(19) United States
(12) Patent Application Publication
(10) Pub. No.: US 2010/0017262 A1
(43) Pub. Date: Jan. 21, 2010

(54) PREDICTING SELECTION RATES OF A DOCUMENT USING CLICK-BASED TRANSLATION DICTIONARIES

(75) Inventors: Rukmini Iyer, Los Altos, CA (US); Hema Raghavan, Arlington, MA (US)

Correspondence Address: BERKELEY LAW & TECHNOLOGY GROUP LLP, 17933 NW EVERGREEN PARKWAY, SUITE 250, BEAVERTON, OR, 97006, US

(73) Assignee: Yahoo! Inc., Sunnyvale, CA (US)

(21) Appl. No.: 12/176,264

(22) Filed: Jul. 18, 2008

(51) Int. Cl. G06Q 10/00; G06F 17/30

(52) U.S. Cl. 705/10; 707/2; 707/E17.009

(57) ABSTRACT

The subject matter disclosed herein relates to predicting selection rates of web-based documents in response to a search query.

### BACKGROUND

1. Field

The subject matter disclosed herein relates to predicting selection rates of web-based documents in response to a search query.

2. Information

Information retrieval is concerned with predicting the relevance of a document given a query. Problems in information retrieval, such as those presented by web-based searches, may be reduced to that of determining the similarity between or among two or more documents, such as text documents, for example. These two documents may both be identified in response to a query. While comparing two documents to determine similarity, word overlap techniques may not be sufficient to determine similarity due to a lexical gap presented by different words or phrases having similar meanings. That is, a pair of words and/or phrases may normally have different meanings, yet they may have similar meanings within a particular context. Accordingly, such a lexical gap may present problems to a search engine.

### BRIEF DESCRIPTION OF THE FIGURES

Non-limiting and non-exhaustive embodiments will be described with reference to the following figures, wherein like reference numerals refer to like parts throughout the various figures unless otherwise specified.

FIG. 1 is a flow diagram of a process to predict selection rates of web-based documents in response to a search query, according to an embodiment.

FIG. 2 is a schematic diagram illustrating an exemplary embodiment of a computing environment system using one or more processes illustrated herein.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, well-known methods, procedures, components, and/or circuits have not been described in detail so as not to obscure claimed subject matter.

Some portions of the detailed description which follow are presented in terms of algorithms and/or symbolic representations of operations on data bits or binary digital signals stored within a computing system memory, such as a computer memory. These algorithmic descriptions and/or representations are the techniques used by those of ordinary skill in the data processing arts to convey the substance of their work to others skilled in the art. An algorithm is here, and generally, considered to be a self-consistent sequence of operations and/or similar processing leading to a desired result. The operations and/or processing involve physical manipulations of physical quantities. Typically, although not necessarily, these quantities may take the form of electrical and/or magnetic signals capable of being stored, transferred, combined, compared and/or otherwise manipulated. It has proven convenient at times, principally for reasons of common usage, to refer to these signals as bits, data, values, elements, symbols, characters, terms, numbers, numerals and/or the like. It should be understood, however, that all of these and similar terms are to be associated with the appropriate physical quantities and are merely convenient labels. Unless specifically stated otherwise, as apparent from the following discussion, it is appreciated that throughout this specification discussions utilizing terms such as “processing”, “computing”, “calculating”, “associating”, “identifying”, “determining” and/or the like refer to the actions and/or processes of a computing platform, such as a computer or a similar electronic computing device, that manipulates and/or transforms data represented as physical electronic and/or magnetic quantities within the computing platform's memories, registers, and/or other information storage, transmission, and/or display devices.

A web page and its contents may comprise a resource of information on the World Wide Web, accessible by a user through a web browser, for example. The World Wide Web may be searched by forming a search query for a web-based search engine, such as Wikepedia®, Yahoo®, and Google®, just to name a few examples. In a particular embodiment, such a search engine may enable a user to search for information on the World Wide Web through a web browser. A search engine may provide a user with a search query response that may include such information, such as web pages, images, advertisements, and other types of documents, for example. Search engines may also mine data available in newsgroups, websites grouped by subject, databases, or open directories, just to name a few examples. Unlike Web directories, which may be maintained by human editors, search engines may operate algorithmically or may be a mixture of algorithmic and human input, for example. Since search engines are well-known in the art, they will not be discussed in detail.

In an embodiment, although claimed subject matter is not limited in this respect, a method includes automatically constructing probabilistic translation dictionaries from click-through information. Such translation dictionaries may include a database and/or data tables, for example. Translation dictionaries may include word synonyms as well as words and/or phrases that include one or more meanings that may be related to other words and/or phrases. For example, a translation dictionary may include the phrase “cheap cars”, which may be related to other words or phrases that likely have a meaning corresponding to inexpensive automobiles, such as “used cars”, “compact cars”, “Kia”, “Hyundai”, and so on. Continuing with the example, such a translation dictionary may also relate “cheap cars” to “job searches” or “bicycles”, since a user entering the query “cheap cars” may be unemployed, and interested in finding a job. Or such a user may have little money so that a bicycle may offer a good alternative to a car. Constructing such translation dictionaries will be described in detail below.

Click-through information may include historical data regarding user selections of documents available on the Internet. The term “click-through” may be based on a particular implementation, wherein a computer mouse or other pointer device may be used with a web browser to “click” on a selected document displayed on a display device. Of course, such a method of selection is only an example, and claimed subject matter is not so limited. In a particular embodiment, a user may submit a search query resulting in a list of documents presented to the user. Such documents may include words, phrases, websites, advertisements, file documents, and so on. As a user selects one or more presented documents from a search, the selections may be automatically logged into a database. Combining document selections from multiple users over an extended period may provide statistical selection-rates for particular documents. Such data may be used to build click-through information, which may comprise daily logs of user actions, which may generally be available to search engines providers, for example.

In an embodiment, translation dictionaries, as mentioned earlier, may include synonyms as well as words and/or phrases that may represent similar contexts. Historical data, such as click-through information, may be used to determine such similar contexts among words and/or phrases. For example, click-through information may include a high selection rate for a particular document in response to a particular query. Accordingly, a translation dictionary, using information from the click-through information, may relate the word and/or phrase of the query with that of the document. More particularly, the translation dictionary may relate the words and/or phrases of the query and the document with a probability. For example, one-hundred percent probability may indicate that the particular document is always selected in response to the particular query, whereas zero percent probability may indicate that the particular document is never selected in response to the particular query. A translation dictionary, which may include a large database of such probabilities, may be used to predict a probability that a user will select a particular document retrieved in response to his/her particular query. In a particular implementation, such a prediction may be applied to a selection rate of web documents or ads among search and advertising applications, for example. In another particular implementation, such a prediction may be applied to a selection rate of text on the Internet, such as job postings, news summaries, answers, and so on, retrieved in response to a user request for information, for example. Of course, such implementations are only examples, and claimed subject matter is not so limited.

In an embodiment, building a database of click-through information may be a continuous, such as a daily, process in order to capture changing conditions on the Internet. For example, information and sales of new commercial products may regularly be added to the Internet so that search results of a query may correspondingly change and expand over time. Accordingly, a translation dictionary that incorporates click-through information may also change over time. In a particular example, a translation dictionary may relate the term of a query “digital camera” to “a40”, which may be a popular model of a digital camera. Such a relation may be represented as a probability that a user will select products, pages, and/or articles including “a40” in response to the “digital camera” query, for example. At a later time, however, a model “a80” may become a more popular digital camera model compared to “a40”. In such a case, a translation dictionary, responsive to multiple users' recent selections on the Internet, for example, may now relate the term of the query “digital camera” to “a80” with a higher selection probability than for “a40”. Also in such a case, “a40” may now be more closely related to a query such as “used digital camera”, since an older model, compared to the new “a80” may be widely available as a used product. Continuing with this example, continually updated click-through information may include user data as users' recent tendency to select products, pages, and/or articles including “a40” in response to “used digital camera” is logged into a click-through information database.

In another embodiment, a method may involve using a probabilistic model to predict the probability that a user will select text retrieved in response to his/her query. Such a model may be used to predict selection rates, or click-through-rates (CTR) of web documents or ads among search and advertising applications, for example. Such a probabilistic model may also be used to predict text, such as job postings, news summaries, and/or answers, just to name a few examples, retrieved in response to a user request for information. For example, if one of two words and/or phrases is a user-composed query and the other is an advertisement, then a probabilistic model may attempt to estimate the CTR of the advertisement. Such a model may also be applied to general web searches, sponsored searches, contextual advertising, and news recommender systems, just to name a few examples. Such a model may also be used to build translation dictionaries, described above. It should be understood, however, that such a list of examples according to a particular embodiment do not limit claimed subject matter.

In an embodiment, a probabilistic model may involve estimating a probability that a user selection may be made, given two words and/or phrases S₁ and S₂. Such a conditional probability term may be expressed as P(C|S₁,S₂). If S₁ and S₂ are each a search query, then the estimated probability may be used by a search engine to present a user with alternate queries. For example, S₁ may be the user's entered query and S₂ may be a potentially recommended alternate query, such potential depending, at least in part, on the estimated probability, which may be determined using a translation dictionary, as discussed above. In other words, a translation dictionary may use historical data of user selection patterns to estimate a probability that a user will select S₁ given S₂, which indicates that S₁ and S₂ may be queries having similar contexts. In another example, if S₁ and S₂ are each documents, then the estimated probability may be used by a search engine to recommend news stories, which may be determined by a translation dictionary to have a relatively high probability of being within the context of S₁ and S₂, for example.

In another embodiment, a probabilistic model may involve estimating a probability that a document may be selected for a query-document pair. Such a model may be referred to as a phrase/word association model, indicating that the query and/or document may comprise words and/or phrases. However, the application of such a model is not limited to a query-document pair, but may also be applied to a document-document pair, where either document may include words, phrases, document files, universal resource locators (URL's), and so on. Of course, these are merely examples, and claimed subject matter is not limited in this regard.

In a particular embodiment, if C is a binary random variable that is “1” to indicate a user selection and is “0” to indicate no selection, then such a model may rank documents by P(C=1|D,Q), as discussed below.

Beginning with an identity,

$$\begin{matrix}P ( C \vert 𝒟 , Q ) = \frac{P ( Q \vert 𝒟 , C ) P ( C \vert 𝒟 )}{P ( Q \vert 𝒟 )} \\ where & ( 1 ) \\ P ( Q \vert 𝒟 , C ) = {\prod }_{i = 1}^{n} P ( {q}_{i} \vert 𝒟 , C ) & ( 2 )\end{matrix}$$

P(C|D,Q) represents the probability of a user selection C given a document D and a query Q, and P(Q|D,C) represents the probability of a query Q given a document D and a user selection C. The variable qᵢ may represent words and/or phrases, so that P(qᵢ|D,C) represents the probability of a word and/or phrase qᵢ given a document D and a user selection C. Accordingly, the right-hand side of equation (2) multiplies each term that includes one of n individual words and/or phrases. P(qᵢ|D,C) can be written as,

$$P ( {q}_{i} \vert 𝒟 , C ) = {λ}_{1} {P}_{TM} ( {q}_{i} \vert 𝒟 , C ) + {λ}_{2} {P}_{B} ( {q}_{i} \vert 𝒟 ) \qquad ( 3 )$$

where P_{TM} is a probability of the translation model and P_{B} is a background probability. The P_{TM} term may be expressed as,

$$\begin{matrix}{P}_{TM} ( {q}_{i} \vert 𝒟 , C ) = {\sum }_{j}^{\vert 𝒟 \vert} P ( {q}_{i} \vert {t}_{j} , C ) P ( {t}_{j} \vert 𝒟 , C ) \\ P ( {t}_{j} \vert 𝒟 ) = \sum {P}_{mle} ( {t}_{j} \vert 𝒟 )\end{matrix} \qquad ( 4 )$$

In an embodiment, a probabilistic model, such as the one described above, may be used to estimate translation tables including translation probabilities that associate a probability P(qᵢ|tⱼ,C) for a word pair qᵢ, tⱼ, where qᵢ may correspond to a word and/or phrase and tⱼ may correspond to another word and/or phrase. For example, qᵢ may correspond to “shoes” and tⱼ may correspond to “sneakers”. In a particular implementation, qᵢ and tⱼ may be equal. In this way, a probabilistic model may assign a non-zero probability to documents for which “translations” or synonyms, tⱼ, of a query term qᵢ occur in the document.

Equation (1), presented above, may be implemented by determining two terms in the numerator and denominator: P(C|D) and P(Q|D). P(C|D) may be considered to be a quality score for an advertisement, for example, independent of a query. In such a case, P(C|D) may be estimated from syntactic and semantic features and historical CTR of the advertisement. P(Q|D) may represent the general probability of a term appearing in a document. P(Q|D) may also be factored into individual word and/or phrase components as P(Q|D)=ΠP(qᵢ|D). Common words such as “a”, “an”, and “the” generally have a higher value of P(qᵢ|D) compared to relatively rare words such as “a40”. Since the term P(qᵢ|D) appears in the denominator it may result in a higher overall score (in Equation 1) for documents that contain more of such uncommon terms. The effect of P(Q|D) in the denominator is therefore similar to that of inverse document frequency (IDF) in a vector space approach, and may be statistically estimated using multiple advertisements displayed for all queries, not just selected query-advertisement pairs. P(Q|D) may be used to discriminate selected advertisements from non-selected advertisements given a particular query. It should be understood, however, that this is merely an example according to a particular embodiment and that claimed subject matter is not limited in this respect.

In an embodiment, one or more sources of information may be used to derive translation tables, such as historical data of selected query-advertisement pairs, web search results, Wikipedia®, user sessions, just to name a few examples. Of course, such a list of examples is not exhaustive and claimed subject matter is not so limited. Smoothing translation probabilities across multiple sources of information may provide statistical robustness and diversity of translations. Also, background probability P_{B}, mentioned above, may provide additional smoothing, for example.

In a particular embodiment, a probabilistic model, such as the one described above, may be used to determine a quality of a web advertisement. A metric of such a quality may include a selection rate for the web advertisement. For example, a new web advertisement may include multiple words and/or phrases to which a probabilistic model, or an associated translation dictionary, may be applied to predict a potential selection rate of the web advertisement. In a particular implementation, if a selection rate is lower than desired, words and/or phases of the new web advertisement may be changed in order to optimize the potential selection rate. In another particular implementation, the potential selection rate of a new web advertisement may be determined so that a search engine provider may charge the advertiser an appropriate fee to post the advertisement on search-result web pages, for example. Of course such implementations are merely examples, and claimed subject matter is not so limited.

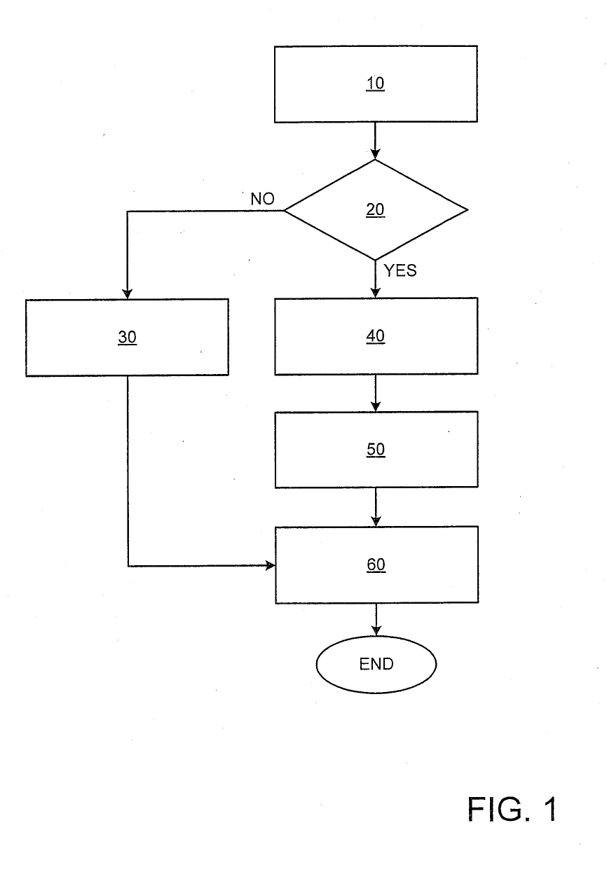

FIG. 1 is a flow diagram of a process to predict selection of web-based documents in response to a search query, according to an embodiment. In the following example, click-through information of a process from one or more web-based search engines may be obtained, as in block 10. Such click-through information may include one or more translation tables that are constructed from previous web searches, as discussed above. Such click-through information may associate one document with another document, though claimed subject matter is not limited in this respect. Since click-through information may be based, at least in part, on historical data, these documents may be currently on the web as well as being present on the web at an earlier time, for example. Previous web searches may include selecting one document in response to a display of another document. For example, one document may comprise a search query and the other document may comprise corresponding search results via a search engine. Such search results may further comprise one or more advertisements, for example, though claimed subject matter is not so limited.

Continuing with the embodiment illustrated in FIG. 1, a phrase/word association model based, at least in part, on click-through information, as described above, may be applied to a document to predict a selection of a document. Such a model may include a probabilistic model described above, for example. A document may have been identified by a search query response, in a particular implementation. Selecting such a document may include, for example, a user selecting a document from a list of multiple documents presented in a search query response. Such a document may comprise one or more words and/or phrases. In block 20, for example, it is determined whether the document comprises more than one word or phrase. If the document comprises only one word and/or phrase, then a phrase/word association model may be applied to the document to predict its selection, as in block 30. However, if the document comprises more than one word and/or phrase, then such words and/or phrases may be separated, as in block 40, before applying a phrase/word association model to the document. Next, as in block 50, a phrase/word association model may be applied to the separated words and/or phrases of the document to predict their individual selections. For example, from equation (2) introduced above, P(Q|D,C) may represent the probability of a query Q given a document D and a user selection C, and qᵢ may represent individual words and/or phrases, as explained above. Accordingly, P(qᵢ|D,C) may represent the probability of a word and/or phrase qᵢ given a document D and a user selection C. Next, as in block 60, individual terms determined in block 50 may be combined to give a result for the document that comprises the multiple words and/or phrases. Such a combining process, for example, may follow the right-hand side of equation (2), which multiplies each term that includes one of the individual words and/or phrases. However, the description of the process of FIG. 1 is merely an example, and claimed subject matter is not limited in this respect.

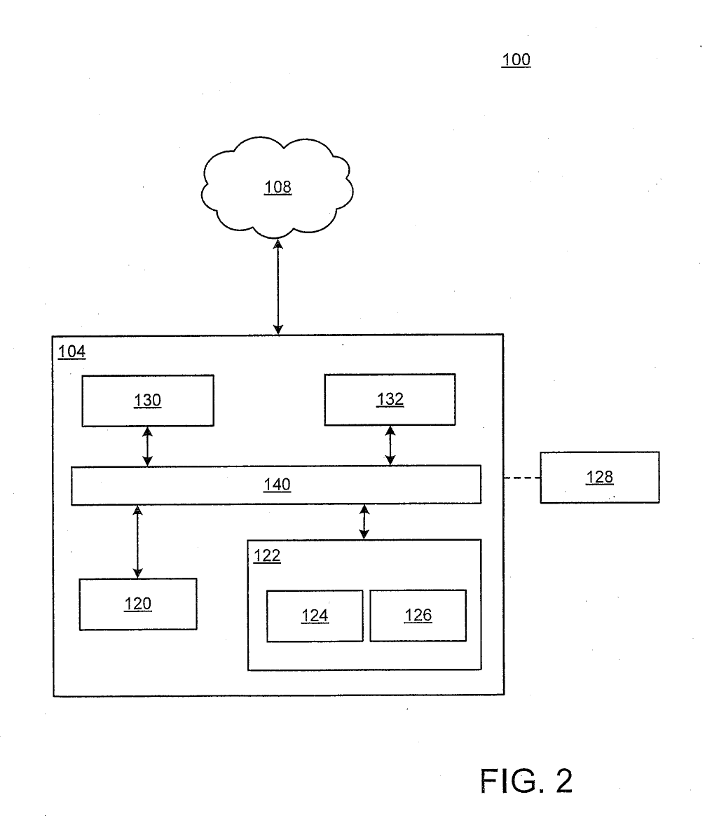

FIG. 2 is a schematic diagram illustrating an exemplary embodiment of a computing environment system 100 that may include one or more devices configurable to process internet browsing or document processing using one or more techniques illustrated herein, for example. Computing device 104, as shown in FIG. 2, may be representative of any device, appliance or machine that may be configurable to exchange data over network 108. By way of example but not limitation, computing device 104 may include: one or more computing devices and/or platforms, such as, e.g., a desktop computer, a laptop computer, a workstation, a server device, or the like; one or more personal computing or communication devices or appliances, such as, e.g., a personal digital assistant, mobile communication device, or the like; a computing system and/or associated service provider capability, such as, e.g., a database or data storage service provider/system, a network service provider/system, an Internet or intranet service provider/system, a portal and/or search engine service provider/system, a wireless communication service provider/system; and/or any combination thereof.

Similarly, network 108, as shown in FIG. 2, is representative of one or more communication links, processes, and/or resources configurable to support exchange of information between computing device 104 and other devices (not shown) connected to network 108. By way of example but not limitation, network 108 may include wireless and/or wired communication links, telephone or telecommunications systems, data buses or channels, optical fibers, terrestrial or satellite resources, local area networks, wide area networks, intranets, the Internet, routers or switches, and the like, or any combination thereof.

It is recognized that all or part of the various devices and networks shown in system 100, and the processes and methods as further described herein, may be implemented using or otherwise include hardware, firmware, software, or any combination thereof. Thus, by way of example but not limitation, computing device 104 may include at least one processing unit 120 that is operatively coupled to a memory 122 through a bus 140. Processing unit 120 is representative of one or more circuits configurable to perform at least a portion of a data computing procedure or process. By way of example but not limitation, processing unit 120 may include one or more processors, controllers, microprocessors, microcontrollers, application specific integrated circuits, digital signal processors, programmable logic devices, field programmable gate arrays, and the like, or any combination thereof.

Memory 122 is representative of any data storage mechanism. Memory 122 may include, for example, a primary memory 124 and/or a secondary memory 126. Primary memory 124 may include, for example, a random access memory, read only memory, etc. While illustrated in this example as being separate from processing unit 120, it should be understood that all or part of primary memory 124 may be provided within or otherwise co-located/coupled with processing unit 120.

Secondary memory 126 may include, for example, the same or similar type of memory as primary memory and/or one or more data storage devices or systems, such as, for example, a disk drive, an optical disc drive, a tape drive, a solid state memory drive, etc. In certain implementations, secondary memory 126 may be operatively receptive of, or otherwise configurable to couple to, a computer-readable medium 128. Computer-readable medium 128 may include, for example, any medium that can carry and/or make accessible data, code and/or instructions for one or more of the devices in system 100.

Computing device 104 may include, for example, a communication interface 130 that provides for or otherwise supports the operative coupling of computing device 104 to at least network 108. By way of example but not limitation, communication interface 130 may include a network interface device or card, a modem, a router, a switch, a transceiver, and the like.

Computing device 104 may include, for example, an input/output 132. Input/output 132 is representative of one or more devices or features that may be configurable to accept or otherwise introduce human and/or machine inputs, and/or one or more devices or features that may be configurable to deliver or otherwise provide for human and/or machine outputs. By way of example but not limitation, input/output device 132 may include an operatively configured display, speaker, keyboard, mouse, trackball, touch screen, data port, etc.

It should also be understood that, although particular embodiments have been described, claimed subject matter is not limited in scope to a particular embodiment or implementation. For example, one embodiment may be in hardware, such as implemented to operate on a device or combination of devices, for example, whereas another embodiment may be in software. Likewise, an embodiment may be implemented in firmware, or as any combination of hardware, software, and/or firmware, for example. Such software and/or firmware may be expressed as machine-readable instructions which are executable by a processor. Likewise, although claimed subject matter is not limited in scope in this respect, one embodiment may comprise one or more articles, such as a storage medium or storage media. This storage media, such as one or more CD-ROMs and/or disks, for example, may have stored thereon instructions, that when executed by a system, such as a computer system, computing platform, or other system, for example, may result in an embodiment of a method in accordance with claimed subject matter being executed, such as one of the embodiments previously described, for example. As one potential example, a computing platform may include one or more processing units or processors, one or more input/output devices, such as a display, a keyboard and/or a mouse, and/or one or more memories, such as static random access memory, dynamic random access memory, flash memory, and/or a hard drive, although, again, claimed subject matter is not limited in scope to this example.

While there has been illustrated and described what are presently considered to be example embodiments, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular embodiments disclosed, but that such claimed subject matter may also include all embodiments falling within the scope of the appended claims, and equivalents thereof.

What is claimed is:

1. A method comprising:
obtaining click-through information from one or more web-based search engines; and
predicting a selection of a document identified by a search query response based at least in part on a phrase/word association model based, at least in part, on said click-through information obtained from one or more previous web searches.

2. The method of claim 1, wherein said click-through information includes one or more translation tables that associate a first previous document with a second previous document.

3. The method of claim 2, further comprising building said translation tables from said previous web searches.

4. The method of claim 3, wherein a result of said previous web searches includes a selection of said first previous document in response to a display of said second previous document.

5. The method of claim 4, wherein said first previous document comprises a search query and said second previous document comprises a search result based, at least in part, on said search query.

6. The method of claim 5, wherein said second previous document comprises an advertisement.

7. The method of claim 5, wherein said search query comprises a phrase comprising two or more words.

8. The method of claim 7, further comprising:
parsing said phrase into said two or more words; and
predicting a selection of each of said two or more words using said phrase/word association model.

9. The method of claim 2, wherein said one or more translation tables include information to predict a probability that said document will be selected based, at least in part, on said first previous document and said second previous document.

10. The method of claim 1, further comprising:
predicting a selection rate of an advertisement using said phrase/word association model; and
changing said advertisement in response to said selection rate.

11. The method of claim 10, further comprising:
determining a fee to an advertiser of said advertisement in response to said selection rate.

12. An article comprising a storage medium comprising machine-readable instructions stored thereon which, if executed by a computing platform, are adapted to enable said computing platform to:
obtain click-through information from one or more web-based search engines; and
predict a selection of a document identified by a search query response based at least in part on a phrase/word association model based, at least in part, on said click-through information obtained from one or more previous web searches.

13. The method of claim 12, wherein said click-through information includes one or more translation tables that associate a first previous document with a second previous document.

14. The method of claim 13, wherein said one or more translation tables include information to predict a probability that said document will be selected based, at least in part, on said first previous document and said second previous document.

15. The method of claim 12, wherein said machine-readable instructions, if executed by a computing platform, are further adapted to enable said computing platform to:
predict a selection rate of an advertisement using said phrase/word association model; and
change said advertisement in response to said selection rate.

16. The method of claim 15, wherein said machine-readable instructions, if executed by a computing platform, are further adapted to enable said computing platform to:
determine a fee to an advertiser of said advertisement in response to said selection rate.

17. An apparatus comprising:
means for obtaining click-through information from one or more web-based search engines; and
means for predicting a selection of a document identified by a search query response based at least in part on a phrase/word association model based, at least in part, on said click-through information obtained from one or more previous web searches.

18. The apparatus of claim 17, wherein said click-through information includes one or more translation tables that associate a first previous document with a second previous document.

19. The apparatus of claim 17, further comprising:
means for predicting a selection rate of an advertisement using said phrase/word association model; and
means for changing said advertisement in response to said selection rate.

20. The apparatus of claim 19, further comprising:
means for determining a fee to an advertiser of said advertisement in response to said selection rate.
